(19) United States
(12) Patent Application Publication
(10) Pub. No.: US 2012/0019508 A1
(43) Pub. Date: Jan. 26, 2012

(54) ELECTROPHORETIC DISPLAY AND PICTURE UPDATE METHOD THEREOF

(75) Inventors: CHIA-HUNG WEI, MIAOLI COUNTY (TW); WEN-YUAN KUO, MIAOLI COUNTY (TW); HSIANG-TSUNG CHUANG, MIAOLI COUNTY (TW)

(73) Assignee: FITIPOWER INTEGRATED TECHNOLOGY INC., MIAOLI COUNTY (TW)

(21) Appl. No.: 13/167,244

(22) Filed: Jun. 23, 2011

(30) Foreign Application Priority Data
Jul. 23, 2010 (TW) 099124353

(51) Int. Cl. G09G 3/34; G06F 3/038

(52) U.S. Cl. 345/213; 345/107

(57) ABSTRACT

An electrophoretic display includes a row driver connected to an electrophoretic display panel via a plurality of gate scanlines, and the row driver has a decoder. When the electrophoretic display is to update a picture that includes only a block to be changed, the decoder decodes a start position and an end position of the block to determine a portion of gate scanlines that are occupied by the block, and the row driver drives only the portion of gate scanlines. Therefore, the update time is shorter and the power consumption is less than that for a full update case.

### FIELD OF THE INVENTION

The present invention is related generally to an electrophoretic display (EPD) and, more particularly, to a picture update method of an EPD.

### BACKGROUND OF THE INVENTION

The EPD has bistability and thus only consumes power at the moment of updating a picture, which makes it superior to other types of displays in some applications. However, the bistability is also a drawback of the EPD because it makes the EPD disadvantageous to display a high updating rate video or animation. Therefore, the EPD is suitable to applications of less varying pictures, such as electronic papers, electronic books, electronic diaries, electronic notepads, electronic newspapers, electronic dictionaries, electronic posters, digital photo frames and so on.

In an EPD, as shown in FIG. 1, an EPD panel 10 includes a plurality of row (or select) electrodes 12 and a plurality of column (or data) electrodes 14, each row electrode 12 and each column electrode 14 having an intersection defining a pixel 16 that is equipped with a thin film transistor 18, whose gate, source and drain are connected to the row electrode 12, the column electrode 14 and a pixel electrode, respectively, so as to selectively apply a driving voltage to the pixel 16 for generating an electric field to drive the charged particles of the pixel 16 to perform electrophoretic migration, thereby representing different lightness levels by reflecting external light. A timing controller 24 is responsible for controlling the row driver 20 and the column driver 22 to drive all the pixels 16 of the EPD panel 10. The row driver 20 selects one gate scanline one time, such that all the pixels 16 on the selected row electrode 12 simultaneously receive respective driving voltages from the column driver 22, depending on the respective gray levels given thereto. When updating a picture, the timing controller 24 receives the gray levels of all the pixels 16 corresponding to a new picture and then, according to the new and old gray levels of each pixel 16, finds out the driving waveforms for driving each pixel 16, and the row driver 20 drives the gate scanlines A0-An sequentially. The driving waveforms for all possible cases of gray level change are stored in a memory in the form of a lookup table for the timing controller 24 to search for. Since the picture update method always sequentially scans all the gate scanlines A0-An for updating a picture, it is difficult to improve the updating rate and reduce power consumption.

More particularly, referring to FIG. 2, even if a new picture has only a changed block 26 as compared to the old picture, such as the case of popping up a dialog box for confirming cancellation, the EPD still sequentially scans all the gate scanlines A0-An and thus wastes most of the time and power. For example, assuming that the dialog box 26 merely occupies a one fourth of the total gate scanlines A0-An, the driving process will waste 75% of the time and power when updating the picture. Since an EPD represents gray levels by moving charged particles, its response speed will be limited by the driving method. In FIG. 2, the left pulse represents an operation time Ts of a gate scanline when this gate scanline is driven. For a given pixel composition, the electrophoretic displacement of its charged particles is positively correlated to the integration of its driving electric fields to time. Therefore, various factors, including pixel thickness, content viscosity, operation voltage, gray level resolution and so on, jointly restrict the inherent minimal operation time Ts of a row electrode. In a simple calculation, assuming that completion of operation of a row electrode requires time Ts and power Ps, updating a whole picture requires time (n+1)Ts and power (n+1)Ps, which are difficult to be reduced through improvement in respect of either material or process.

Therefore, it is desired a faster and lower power picture update method for partially updating a picture.

### SUMMARY OF THE INVENTION

An objective of the present invention is to provide a fast picture update method of an EPD.

Another objective of the present invention is to provide a low power picture update method of an EPD.

According to the present invention, an EPD includes an EPD panel, a row driver connected to the EPD panel via a plurality of gate scanlines, a column driver connected to the EPD panel via a plurality of source datalines, and a timing controller connected to the row driver and the column driver. The row driver has a decoder, and when the EPD is to update a picture including only a block to be changed, the decoder decodes a start position and an end position of the block, so as to determine the gate scanlines occupied by the block such that the row driver drives only these gate scanlines.

According to the present invention, a picture update method of an EPD drives only a portion of gate scanlines of an EPD panel, if the new picture has only a block to be changed as compared to the old picture.

Since the picture update method according to the present invention does not scan all gate scanlines of an EPD when the new picture is a partially changed one, it will have less update time and lower power consumption.

### BRIEF DESCRIPTION OF THE DRAWINGS

These and other objects, features and advantages of the present invention will become apparent to those skilled in the art upon consideration of the following description of the preferred embodiments of the present invention taken in conjunction with the accompanying drawings, in which:

FIG. 1 is a conventional EPD;

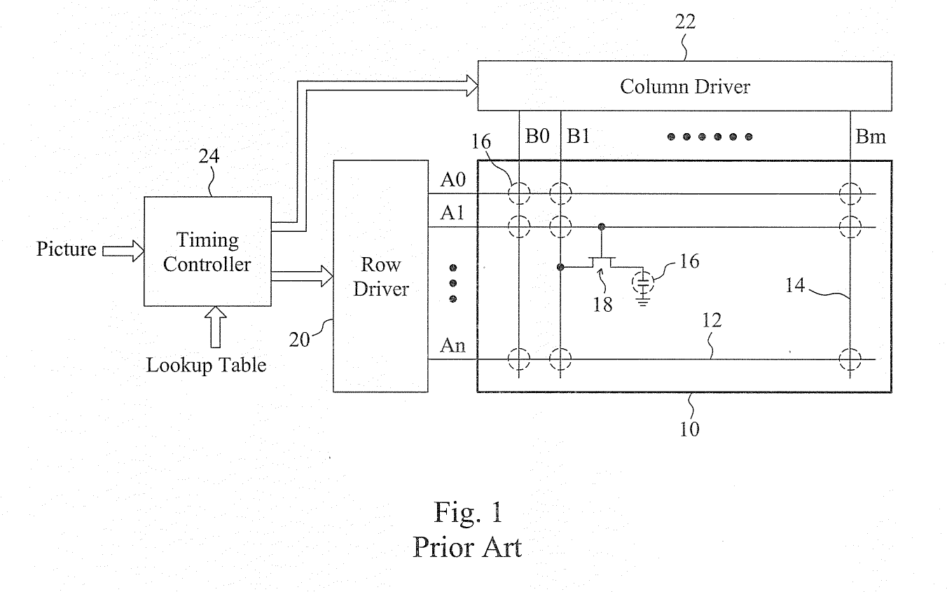

FIG. 2 illustrates a conventional picture update operation of an EPD;

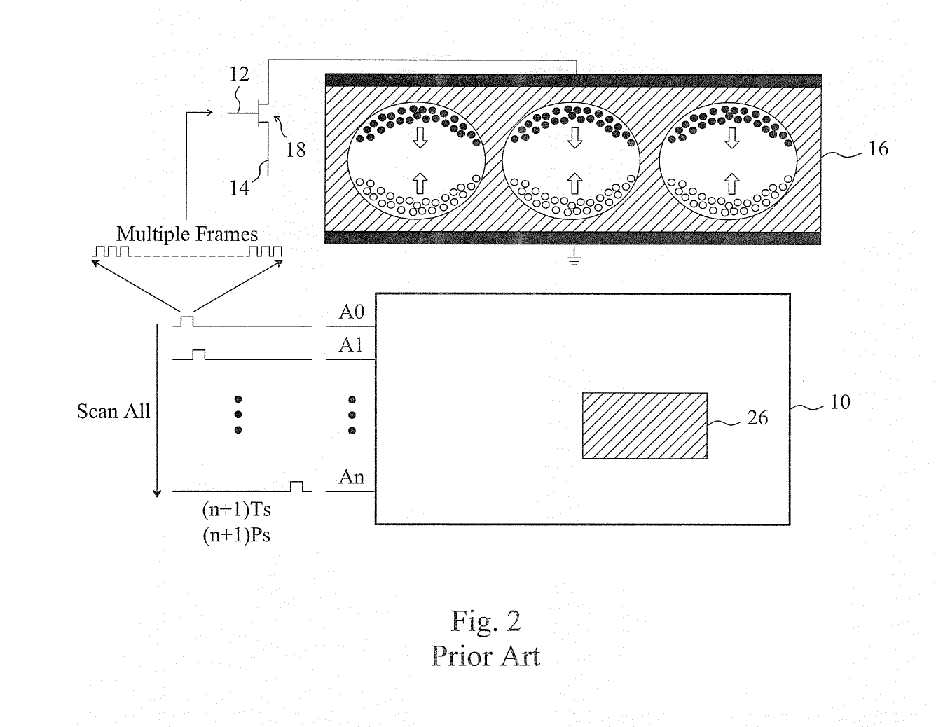

FIG. 3 is a flowchart of a picture update method of an EPD according to the present invention;

FIG. 4 is an EPD according to the present invention;

FIG. 5 illustrates a partial update operation of an EPD according to the present invention; and

FIG. 6 illustrates a partial update operation of an EPD according to the present invention.

### DETAILED DESCRIPTION OF THE INVENTION

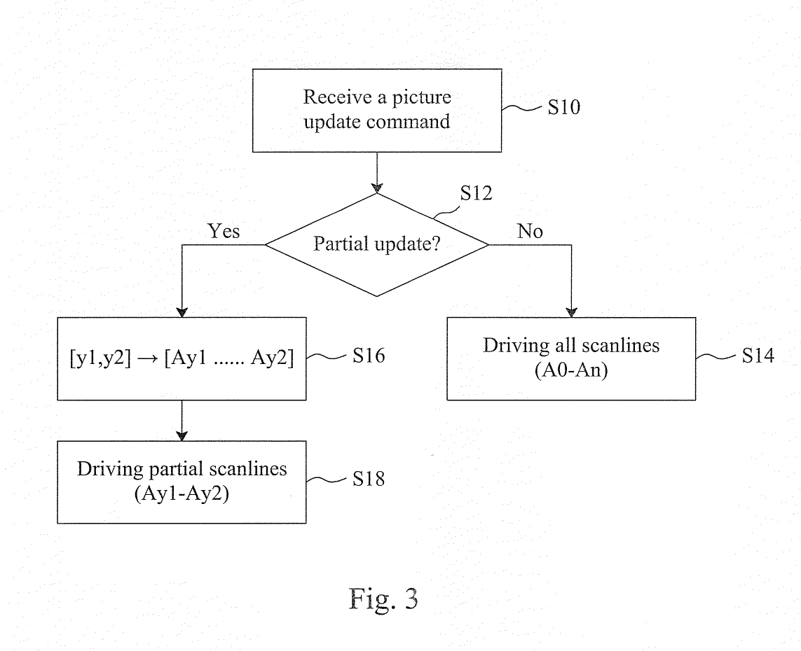

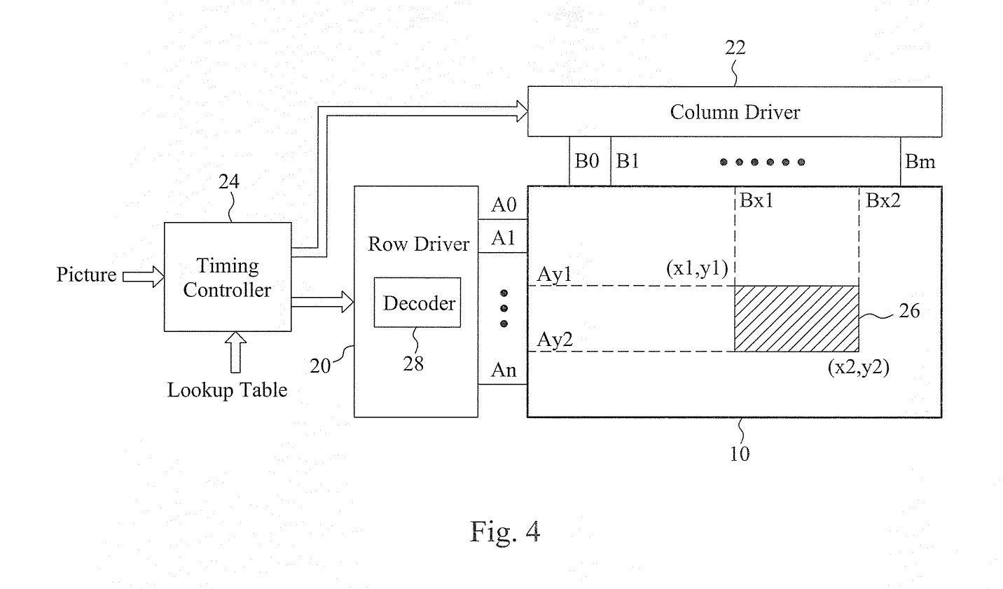

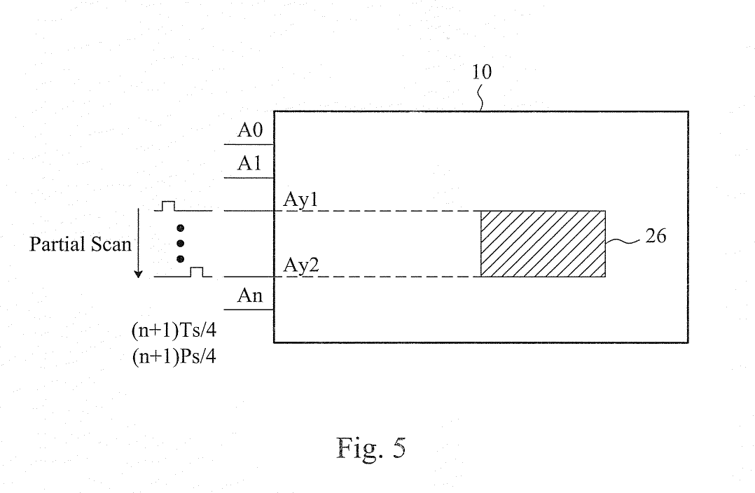

FIG. 3 is a flowchart of a picture update method of an EPD according to the present invention and FIG. 4 is an EPD according to the present invention. Referring to FIGS. 3 and 4, after step S10 receives a picture update command, step S12 identifies it is a full update or a partial update. If there is no need for partial update, the process goes to step S14 and the timing controller 24 will control the row driver 20 to sequentially drive all gate scanlines A0-An, as conventionally. On the contrary, if the picture has only a block 26 changed, the EPD will select only the gate scanlines occupied by the block 26 to drive. More particularly, after receiving the picture to be updated, the timing controller 24 can identify the start position (x1,y1) and end position (x2,y2) of the changed block in the picture, and sends the coordinates y1 and y2 to the row driver 20. The row driver 20 has a decoder 28 to decode the coordinates y1 and y2 to obtain the gate scanlines Ay1-Ay2 occupied by the block 26, as shown in step S16. Then, in step S18, the row driver 20 drives only the gate scanlines Ay1-Ay2. Referring to FIG. 5, assuming that the gate scanlines Ay1-Ay2 take only one fourth of the total gate scanlines A0-An, the time and power consumption for one time of updating a picture can be reduced to one fourth. In an extreme case, one time of updating a picture only requires driving a single gate scanline.

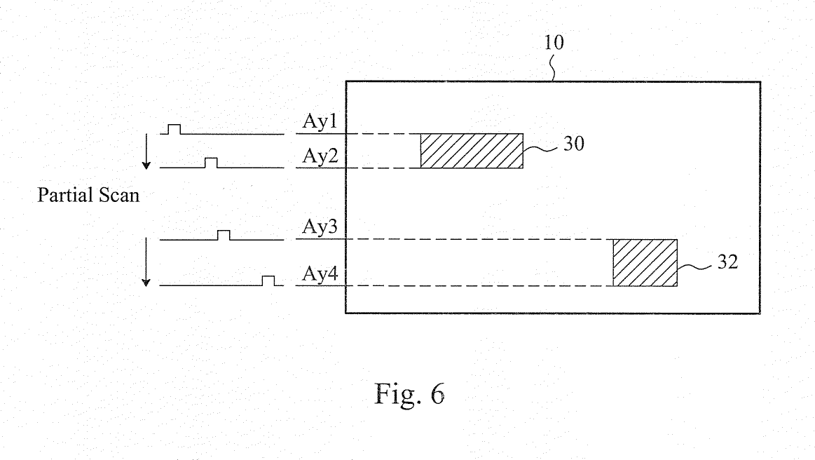

For the above illustration, it is appreciated that the partial updating is not limited to a single continuous block. For example, as shown in FIG. 6, there are two blocks 30 and 32 to be updated, so the gate scanlines Ay1-Ay2 and Ay3-Ay4 are driven for this purpose.

From a straightforward point of view, the aforementioned picture update method is similar to a picture in picture (PIP) display. However, the picture update method according to the present invention uses the bistability of the EPD and thus drives only the gate scanlines occupied by the changed block.

Referring to FIGS. 4 and 5, it is clear that only the decoder 28 is additionally used to reduce the number of driven gate scanlines when updating a picture, with the rest part of the system remaining as conventionally. Thus, the present invention can directly apply to the existing EPD products.

Due to the EPD has a special driving method, its response speed is slower than other types of displays. However, the present invention helps to dramatically reduce the picture update time of the EPD, thus compensates the weakness of slow response speed of the EPD.

As to power consumption, since the EPD does not need a backlight source as the liquid crystal display (LCD) requires, the EPD has a much higher ratio of the consumption power for picture updating to the overall power consumption than that of an LCD. Therefore, once the power consumed by updating pictures is reduced, the efficiency of the EPD can be dramatically improved.

While the present invention has been described in conjunction with preferred embodiments thereof, it is evident that many alternatives, modifications and variations will be apparent to those skilled in the art. Accordingly, it is intended to embrace all such alternatives, modifications and variations that fall within the spirit and scope thereof as set forth in the appended claims.

What is claimed is:

1. An electrophoretic display comprising:
an electrophoretic display panel;
a row driver having a decoder;
a column driver;
a plurality of gate scanlines connected between the row driver and the electrophoretic display panel;
a plurality of source datalines connected between the column driver and the electrophoretic display panel; and
a timing controller connected to the row driver and the column driver;
wherein the decoder decodes a start position and an end position of a picture in picture provided by the timing controller to determine a portion of the plurality of gate scanlines that are occupied by the picture in picture, and the row driver drives only the portion of the plurality of gate scanlines.

2. A picture update method of an electrophoretic display including an electrophoretic display panel and a row driver connected to the electrophoretic display panel via a plurality of gate scanlines, the picture update method comprising the steps of:
A. determining a portion of the plurality of gate scanlines that are occupied by a picture in picture; and
B. driving only the portion of the plurality of gate scanlines.

3. The picture update method of claim 2, wherein the step A comprises the step of decoding a start position and an end position of the picture in picture to determine the portion of the plurality of gate scanlines.
